(19) United States
(12) Patent Application Publication
(10) Pub. No.: US 2025/0306374 A1
(43) Pub. Date: Oct. 2, 2025

(54) COMBINING LIGHT FROM MULTIPLE IMAGE SOURCES WITHIN A REFLECTIVE FACET WAVEGUIDE

(71) Applicant: GOOGLE LLC, Mountain View, CA (US)

(72) Inventors: Daniel Adema, Kitchener (CA); Shreyas Potnis, Kitchener (CA)

(21) Appl. No.: 18/863,282

(22) PCT Filed: May 9, 2023
(86) PCT No.: PCT/US2023/021498

§ 371 Date: Nov. 5, 2024

Related U.S. Application Data
(60) Provisional application No. 63/341,083, filed on May 12, 2022.

(51) Int. Cl. G02B 27/01; G02B 27/00

(52) U.S. Cl. CPC G02B 27/0172; G02B 27/0081; G02B 2027/0114; G02B 2027/0125; G02B 2027/0178

(57) ABSTRACT

A waveguide for an eyewear display includes a set of reflective incoupler facets to incouple light and/or a set of reflective exit pupil expander (EPE) facets to expand the incoupled light in a first direction. The reflective incoupler facets are each designed to incouple light of a particular optical characteristic such as a particular wavelength range or polarization state and transmit light of other optical characteristics incoupled at other ones of the reflective incoupler facets. The reflective EPE facets receive light from multiple sources (e.g., multiple incouplers). In some configurations, each of the reflective EPE facets is designed to reflect or transmit light incident thereon to direct light to an outcoupler in a more uniform manner.

### BACKGROUND

In an augment reality (AR) or mixed reality (MR) eyewear display, light from an image source is coupled into a light guide substrate, generally referred to as a waveguide or a lightguide, by an input optical coupling (i.e., an “incoupler) which can be formed on a surface of the substrate or disposed within the substrate. Once the light beams have been coupled into the waveguide, the light beams are “guided” through the substrate, typically by multiple instances of total internal reflection (TIR), to then be directed out of the waveguide by an output optical coupling (i.e., an “outcoupler”). In some cases, another optical component known as an exit pupil expander is positioned in the optical path between the incoupler and the outcoupler to expand the light beams in at least one dimension. The light beams projected from the waveguide by the outcoupler overlap at an eye relief distance from the waveguide forming an exit pupil within which a virtual image generated by the image source can be viewed by the user of the eyewear display.

### SUMMARY

In a first embodiment, a waveguide includes an incoupler comprising a plurality of reflective facets, each reflective facet of the plurality of reflective facets to selectively reflect light having a first optical characteristic of a plurality of optical characteristics, wherein light having each one of the plurality of optical characteristics is received from a different input. The plurality of reflective facets is positioned such that one or more reflective facets of the plurality of reflective facets is in a path of light propagation of light incoupled at another one of the plurality of reflective facets.

In some aspects of the first embodiment, one or more reflective facets of the plurality of reflective facets allows light incoupled at other ones of the plurality of reflective facets to pass through.

In some aspects of the first embodiment, the plurality of optical characteristics are different wavelength ranges, and wherein the one or more reflective facets of the plurality of reflective facets comprises a dichroic mirror coating. In some aspects of the first embodiment, a first facet of the plurality of reflective facets is configured to reflect light having a first wavelength range to propagate light having the first wavelength range within the waveguide. In some aspects of the first embodiment, a second facet of the plurality of reflective facets is configured to allow light having the first wavelength range to pass through and reflect light having a second wavelength range different from the first wavelength range to propagate light having the second wavelength range within the waveguide. In some aspects of the first embodiment, a third facet of the plurality of reflective facets is configured to allow light having the first wavelength range and the second wavelength range to pass through and reflect light having a third wavelength range different from the first wavelength range and the second wavelength range to propagate light having the third wavelength range within the waveguide. In some aspects of the first embodiment, a first facet of the plurality of reflective facets is configured to reflect light of a first wavelength range corresponding to blue light, a second facet of the plurality of reflective facets is configured to reflect light of a second wavelength range corresponding to green light, and a third facet of the plurality of reflective facets is configured to reflect light of a third wavelength range corresponding to red light. In some aspects of the first embodiment, the second facet is configured to allow light having the first wavelength range to pass through, and the third facet is configured to allow light having the first wavelength range and the second wavelength range to pass through. In some aspects of the first embodiment, a first facet of the plurality of reflective facets is configured to reflect light of a first wavelength range corresponding to red light, a second facet of the plurality of reflective facets is configured to reflect light of a second wavelength range corresponding to green light, and a third facet of the plurality of reflective facets is configured to reflect light of a third wavelength range corresponding to blue light. In some aspects of the first embodiment, the second facet is configured to allow light having the first wavelength range to pass through, and the third facet is configured to allow light having the first wavelength range and the second wavelength range to pass through.

In some aspects of the first embodiment, the plurality of optical characteristics are different polarization states. In some aspects of the first embodiment, a first facet of the plurality of reflective facets comprises a mirror to reflect light having a first polarization state and wherein a second facet of the plurality of reflective facets comprises a polarization beam splitter. In some aspects of the first embodiment, the polarization beam splitter allows light having the first polarization state incoupled at the first facet to pass through and reflects light having a second polarization state.

In some aspects of the first embodiment, light having each of the plurality of optical characteristics is emitted from a different light emitting source.

In a second embodiment, a waveguide includes an exit pupil expander (EPE) including a plurality of reflective facets to receive light from multiple sources, the plurality of reflective facets arranged along a first direction and direct light in a second direction toward an outcoupler of the waveguide, wherein the first direction is different from the second direction.

In some aspects of the second embodiment, a first source of the multiple sources transmits light toward the first direction and a second source of the multiple sources transmits light toward the second direction. In some aspects of the second embodiment, a first subset of reflective facets of the plurality of reflective facets comprises an input reflective facet to receive light from the first source, reflect a first portion of the received light in the second direction, and allow a second portion of the received light to pass through to other reflective facets in the first subset, wherein each of the other reflective facets in the first subset reflects a corresponding first portion of light incident thereon in the second direction and allows a corresponding second portion of light incident thereon to pass through in the first direction. In some aspects of the second embodiment, a second subset of reflective facets of the plurality of reflective facets comprises a second input reflective facet to receive light from the second source and reflect the received light to other reflective facets in the second subset, wherein the second input reflective facet corresponds to a final reflective facet in the first subset and includes a surface with total reflectivity or substantially total reflectivity of light from the first source and the second source. In some aspects of the second embodiment, each of the other reflective facets in the second subset reflects a corresponding first portion of light incident thereon in the second direction and allows a corresponding second portion of light incident thereon to pass through in the first direction.

In some aspects of the second embodiment, a first source and a second source transmit light toward the second direction. In some aspects of the second embodiment, a first subset of reflective facets of the plurality of reflective facets comprises an input reflective facet to receive light from the first source, allow a first portion of the received light to pass through in the second direction, and reflect a second portion of the received light in the first direction toward other reflective facets in the first subset. In some aspects of the second embodiment, the other reflective facets in the first subset reflect a corresponding portion of light incident thereon in the second direction and allow a remaining corresponding portion of light incident thereon to pass through in the first direction. In some aspects of the second embodiment, a second subset of reflective facets of the plurality of reflective facets receives light from the second source, wherein the second subset of facets comprises an input facet configured to initially receive light from the second source, transmit a first portion of the received light in the second direction, and reflect a second portion of the received light toward other facets in the second subset. In some aspects of the second embodiment, the other facets in the second subset reflect a portion of light incident thereon in the second direction.

In a third embodiment, an eyewear display includes a waveguide either one of or both of the first and second embodiments.

In a fourth embodiment, a method includes, at each one of a plurality of reflective facets in an incoupler of a waveguide, selectively reflecting light having a first optical characteristic of a plurality of optical characteristics, wherein light having each one of the plurality of optical characteristics is received from a different input. The method further includes, at one or more of the plurality of reflective facets, allowing light incoupled at another one or more of the plurality of reflective facets to pass through.

In a fifth embodiment, a method includes receiving light from a plurality of sources at a plurality of reflective facets in an exit pupil expander (EPE) of a waveguide, wherein the plurality of reflective facets is arranged along a first direction. The method further includes directing light in a second direction toward an outcoupler of the waveguide, wherein the first direction is different from the second direction.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example eyewear display, in accordance with some embodiments.

FIG. 2 shows an example diagram of a projection system that projects display light representing images onto the eye of a user via an eyewear display, such as the eyewear display of FIG. 1, in accordance with some embodiments.

FIG. 3 shows an example of light propagation within a waveguide of a projection system, such as the projection system of FIG. 2, in accordance with some embodiments.

FIG. 4 shows an example incoupler with a plurality of reflective incoupler facets to selectively incouple light based on different wavelength ranges, in accordance with some embodiments.

FIG. 5 shows an example incoupler with a plurality of reflective incoupler facets to selectively incouple light based on different polarization states, in accordance with some embodiments.

FIGS. 6 to 8 each show an example of an exit pupil expander (EPE) with a plurality of reflective EPE facets, in accordance with some embodiments.

### DETAILED DESCRIPTION

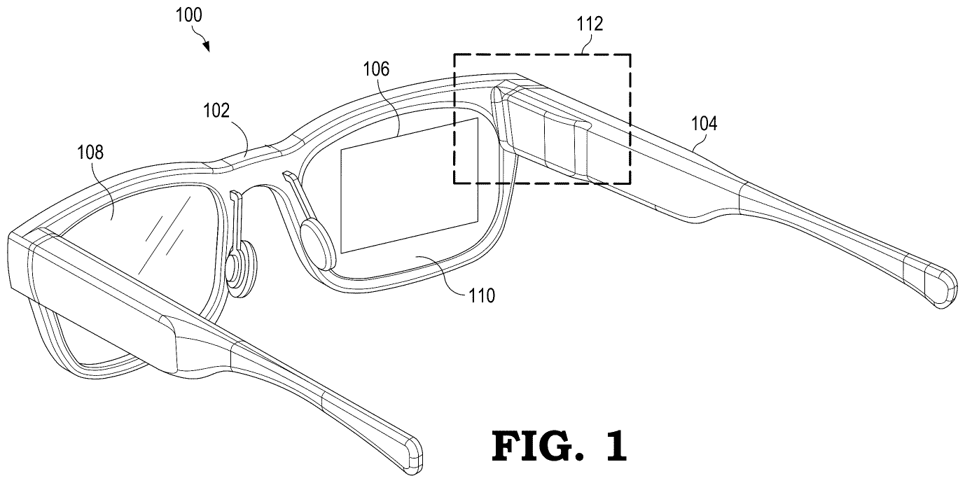

In some waveguides, one or more of the incoupler, the exit pupil expander, and the outcoupler are formed as a set of reflective facets. For example, the incoupler is formed as a first set of reflective incoupler facets for receiving and incoupling light from the image source into the waveguide. In another example, the exit pupil expander (EPE) is formed as a second set of reflective EPE facets for receiving the incoupled light, expanding it in one direction, and directing the expanded light toward the outcoupler of the waveguide. Conventional eyewear displays having a waveguide with reflective facets generally have limited image display efficiency due to having to balance the need for the user to see through the reflective facets (to allow the user to observe the real-world environment) with increasing the display brightness or display uniformity of the images generated by the image source of the eyewear display (to increase the quality of the generated image that is observed by the user). Typically, this balancing is achieved by reducing the generated image's display brightness, thus negatively impacting the quality of the generated images observed by the user. To improve display brightness, some eyewear displays include multiple image sources. In some systems, the light is combined prior to the light entering the waveguide. However, this approach increases the number of components in the optical relay system of the eyewear display, thereby increasing the volume the system occupies in the eyewear display which in some cases may have a limited form factor. FIGS. 1-8 present techniques to combine light from multiple image sources within a reflective facet waveguide, thereby increasing the brightness and uniformity of the image generated by the eyewear display while supporting a relatively small and compact display form factor.

To illustrate, in a first embodiment, an incoupler of a waveguide includes a plurality of reflective incoupler facets. Each reflective incoupler facet of the plurality reflective incoupler facets selectively reflects light having one optical characteristic of a plurality of optical characteristics. In some embodiments, light having each one of the plurality of optical characteristics is received from a different input. Each different input, in some embodiments, is associated with a different light emitting source. For example, the plurality of optical characteristics are different wavelength ranges or light colors, where each wavelength range or light color is emitted from one of multiple image sources or from a different portion of an image source such as a microLED display panel. In some embodiments, the reflective incoupler facets are positioned such that they are along a path of light propagation within the waveguide. In this manner, each subsequent reflective incoupler facet after the first reflective incoupler facet allows light incoupled at the previous reflective incoupler facet to pass through. In one embodiment, the first reflective incoupler facet reflects red light so that red light is incoupled into the waveguide. A second reflective incoupler facet of plurality of reflective incoupler facets reflects green light so that green light is incoupled into the waveguide but allows the red light incoupled at the first reflective incoupler facet to pass through. For example, the second reflective incoupler facet includes a dichroic mirror coating to transmit red light and reflect green light. A third reflective incoupler facet reflects blue light so that blue light is incoupled into the waveguide but allows the red light incoupled at the first reflective incoupler facet and the green light incoupled at the second reflective incoupler facet to pass through. For example, the third reflective incoupler facet includes a dichroic mirror coating to transmit both red light and green light but reflect blue light. Accordingly, each of the reflective incoupler facets selectively incouples light of a particular wavelength range or color while not affecting the light of other wavelength ranges or colors incoupled at the other reflective incoupler facets. Thus, the combination of light from the multiple image sources is performed within the waveguide and not prior to waveguide entry. This increases the brightness of the generated image displayed to the user while conforming to the size restrictions associated with an eyewear display with a small form factor (e.g., an eyewear display with an eyeglasses frame form factor).

To illustrate, in a second embodiment, an exit pupil expander (EPE) of a waveguide includes a plurality of reflective EPE facets. The plurality of reflective EPE facets is arranged along a first direction and directs light in a second direction (different from the first direction) toward an outcoupler of the waveguide. In some embodiments, each of the plurality of reflective EPE facets includes a particular reflection to transmission ratio (e.g., each reflective EPE facet has a particular % reflection and % transmission) for the incoupled light. For example, the plurality of reflective EPE facets can be coated with different coatings to selectively reflect or transmit light to balance the uniformity of the amount of light directed to the outcoupler. In some embodiments, the plurality of reflective EPE facets is divided into a plurality of subsets where each subset is configured to receive light from a different input source. For example, each input source can correspond to a different incoupler or different set of light beams incoupled by an incoupler. Thus, a first subset of reflective EPE facets receives light from a first input source, and a second subset of reflective EPE facets receives light from a second input source. Each subset of the reflective EPE facets includes a first reflective EPE facet to initially receive light from the corresponding input source and direct a first portion of the light toward the second direction while directing a second portion of the light in the first direction toward the remaining reflective EPE facets in the subset. Each remaining reflective EPE facet in the subset similarly directs a first portion of light incident thereon to the second direction and directs a second portion of light incident thereon in the first direction the remaining reflective EPE facets in the subset (if any). Accordingly, the amount of light directed toward the outcoupler from the EPE can be manipulated to be substantially the same, thus improving the uniformity of light to eventually be outcoupled by the waveguide while conforming to the size limitations associated with an eyewear display with a restricted form factor (e.g., an eyewear display with an eyeglasses frame form factor).

FIGS. 1-8 show apparatuses and techniques for increasing the brightness and/or uniformity of images generated by an AR/MR eyewear display by combining light from multiple sources within a waveguide of the AR/MR eyewear display. While the disclosed apparatuses and techniques are described with respect to an example display system, it will be appreciated that present disclosure is not limited to implementation in this particular display system, but instead may be implemented in any of a variety of display systems using the guidelines provided herein.

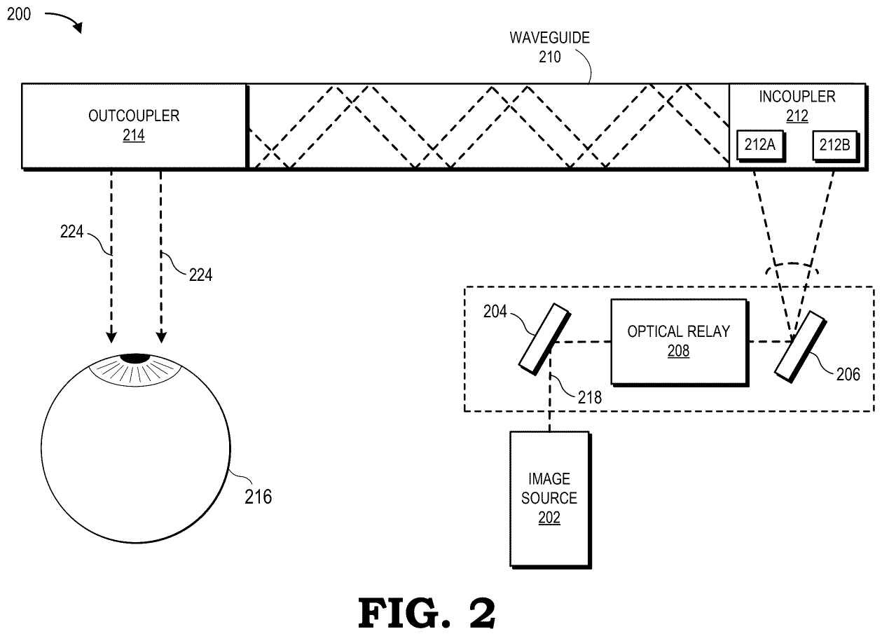

FIG. 1 illustrates an example eyewear display 100 in accordance with various embodiments. The eyewear display 100 (also referred to as a wearable heads up display (WHUD), head-mounted display (HMD), near-eye display, or the like) has a support structure 102 that includes an arm 104, which houses a micro-display projection system configured to project images toward the eye of a user, such that the user perceives the projected images as being displayed in a field of view (FOV) area 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images toward the eye of the user, such as an image source (also referred to as light engine, optical engine, projector, or the like) and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. The support structure 102, in some embodiments, further includes processing circuitry or control circuitry to carry out functions of the eyewear display 100 such as eye tracking functions, for example. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in a temple region 112 of the support structure 102 or in a nose bridge region the support structure 102. It should be noted that while an example form factor is depicted, it will be appreciated that in other embodiments the eyewear display 100 may have a different shape and appearance from the eyeglasses frame depicted in FIG. 1.

One or both of the lens elements 108, 110 are used by the eyewear display 100 to provide an AR pr MR display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from an image source in the eyewear display 100. For example, light used to form a perceptible image or series of images may be projected by the image source of the eyewear display 100 onto the eye of the user via a series of optical elements, such as a waveguide formed at least partially in the corresponding lens element, one or more scan mirrors, one or more optical relays, and/or one or more prisms. In some embodiments, multiple image sources are included in the support structure 102. In some cases, the multiple image sources are located in the temple region 112, in the nose bridge region, or in a combination of the two regions (e.g., one image source in the temple region 112 and another image source in the nose bridge region). In some embodiments, the waveguide includes one or more sets of optical components where each set of optical components includes an incoupler, an exit pupil expander, and an outcoupler. Each incoupler is configured to incouple light from the one or more image sources and has a corresponding exit pupil expander and outcoupler for expanding light in at least one dimension and outcoupling light via the FOV area 106, respectively. One or both of the lens elements 108, 110 thus includes at least a portion of a waveguide that routes display light received by the one or more incouplers of the waveguide to the corresponding one or more outcouplers of the waveguide, which output the display light toward an eye of a user of the eyewear display 100. The display light is modulated and projected onto the eye of the user such that the user perceives the display light as an image in the FOV area 106. In addition, each of the lens elements 108, 110 is sufficiently transparent to allow a user to see through the lens elements to provide a field of view of the user's real-world environment such that the image appears superimposed over at least a portion of the real-world environment.

In some embodiments, each of the one or more image sources is a matrix-based projector, a scanning laser projector, or any combination of a modulative light source such as a laser or one or more LEDs and a dynamic reflector mechanism such as one or more dynamic scanners or digital light processors. In some embodiments, the image source includes multiple laser diodes (e.g., a red laser diode, a green laser diode, and/or a blue laser diode) and at least one scan mirror (e.g., two one-dimensional scan mirrors, which is a micro-electromechanical system (MEMS)-based or piezo-based), for example. The image source is communicatively coupled to a controller and a non-transitory processor-readable storage medium or memory storing processor-executable instructions and other data that, when executed by the controller, cause the controller to control the operation of the image source. In some embodiments, the controller controls a scan area size and scan area location for the image source and is communicatively coupled to a processor (not shown) that generates content to be displayed at the eyewear display 100. The image source scans light over a variable area, designated the FOV area 106, of the eyewear display 100. The scan area size corresponds to the size of the FOV area 106 and the scan area location corresponds to a region of one of the lens elements 108, 110 at which the FOV area 106 is visible to the user. Generally, it is desirable for a display to have a wide FOV area to accommodate the outcoupling of light across a wide range of angles. Herein, the range of different user eye positions that will be able to see the display is referred to as the eyebox of the eyewear display 100.

The techniques and apparatuses of the present disclosure increase the brightness and/or uniformity of the light delivered via the FOV area 106, thereby improving the quality of the image perceived by the user. In some embodiments, the incoupler and/or the exit pupil expander (EPE) of the waveguide are each implemented as a set of reflective facets. For example, the incoupler includes a plurality of reflective incoupler facets to each incouple light of a particular optical characteristic (e.g., wavelength range or polarization state). This increases the amount of light incoupled by the waveguide, thus increasing the brightness of the image delivered to the user of the eyewear display 100. As another example, the EPE includes a plurality of reflective EPE facets that are each designed to direct a similar amount of light to the outcoupler of the waveguide. This balances the uniformity of the light forwarded to the outcoupler, thus improving the uniformity of the image delivered to the user of the eyewear display 100.

FIG. 2 illustrates a diagram of a projection system 200 that projects display light representing images onto the eye 216 of a user via a waveguide in an eyewear display, such as eyewear display 100 illustrated in FIG. 1. The projection system 200 includes an image source 202, an optical scanner 220, and a waveguide 210. One image source 202 and corresponding optical scanner 220 is illustrated in FIG. 2 for clarity purposes, but in some embodiments, multiple image sources 202 and optical scanners 220 are included in the projection system 200.

In some embodiments, the image source 202 includes one or more laser light sources configured to generate and output laser light (e.g., visible laser light such as red, blue, and green laser light and/or non-visible laser light such as infrared laser light) or one or more microLED light sources configured to generate and output light via a plurality of microLED elements in a microLED display panel. In some embodiments, the image source 202 is coupled to a controller or driver (not shown), which controls the timing of emission of display light from the light sources of the image source 202 (e.g., in accordance with instructions received by the controller or driver from a computer processor coupled thereto) to modulate the display light 218 to be perceived as images when output to the retina of the eye 216 of the user.

In some embodiments, the optical scanner 220 includes a first scan mirror 204, a second scan mirror 206, and an optical relay 208. In some cases, one or both of the scan mirrors 204 and 206 are MEMS mirrors. For example, the scan mirror 204 and the scan mirror 206 are MEMS mirrors that are driven by respective actuation voltages to oscillate during active operation of the laser projection system 200, causing the scan mirrors 204 and 206 to scan the display light 218 toward an incoupler 212 of the waveguide 210.

In some embodiments, the waveguide 210 of the projection system 200 includes one or more sets of optical components. Each set of optical components includes an incoupler 212, an exit pupil expander (not shown in FIG. 2), and an outcoupler 214. The term “waveguide,” as used herein, will be understood to mean a combiner using total internal reflection (TIR), or via a combination of TIR, specialized filters, and/or reflective surfaces, to transfer light from an incoupler to a corresponding outcoupler. For display applications, the light is representative of a collimated image, for example, and the waveguide transfers and replicates the collimated image to the eye. In general, the terms “incoupler”, “exit pupil expander”, and “outcoupler” will be understood to refer to any type of optical grating structure, including, but not limited to, reflective facets, diffraction gratings, slanted gratings, blazed gratings, holograms, holographic optical elements (e.g., optical elements using one or more holograms), volume diffraction gratings, volume holograms, surface relief diffraction gratings, and/or surface relief holograms. In some embodiment, the incoupler includes one or more facets or reflective surfaces. In some embodiments, a given incoupler or outcoupler is configured as a transmissive diffraction grating that causes the incoupler or outcoupler to transmit light and to apply designed optical function(s) to the light during the transmission. In some embodiments, a given incoupler or outcoupler is a reflective diffraction grating that causes the incoupler or outcoupler to reflect light and to apply designed optical function(s) to the light during the reflection. In the present example, the display light 218 received at the incoupler 212 is propagated to the outcoupler 214 via the waveguide 210 using TIR. The display light 218 is then output to the eye 216 of a user via the outcoupler 214.

In some embodiments, the incoupler 212 includes a plurality of reflective incoupler facets 212A, 212B. Each reflective incoupler facet 212A, 212B is configured to incouple light of one optical characteristic of a plurality of incoupler characteristics. For example, reflective incoupler facet 212B incouples light in the blue and green wavelength range and reflective incoupler facet 212A incouples light in the red wavelength range. In another example, reflective incoupler facet 212B incouples light with a p-polarization state and reflective incoupler facet 212A incouples light with an s-polarization state. In either case, reflective incoupler facet 212A allows light incoupled at reflective incoupler facet 212B to pass through. Designing each reflective incoupler facet 212A, 212B to incouple light of a particular optical characteristic increases the amount of light incoupled into the waveguide 210, thereby increasing the amount of light 224 that is eventually outcoupled to the eye 216 of the user. This increases the brightness of the image delivered to the user.

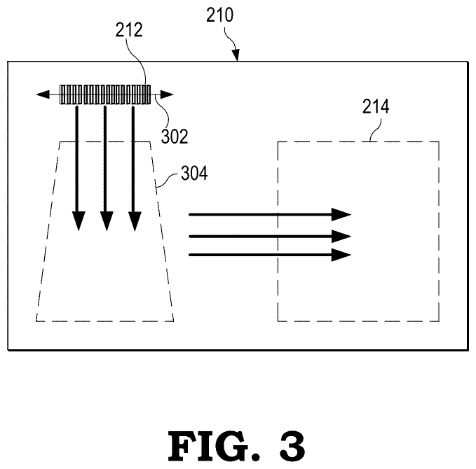

FIG. 3 shows an example of light propagation within a set of optical components of the waveguide 210 of the projection system 200 of FIG. 2. As shown, light is received via the incoupler 212, directed into an exit pupil expander (EPE) 304, and then routed to the outcoupler 214 to be output from the waveguide 210 (e.g., toward the eye of the user). In some embodiments, the EPE 304 expands one or more dimensions of the eyebox of an eyewear display that includes the projection system 200 (e.g., with respect to what the dimensions of the eyebox of the eyewear display would be without the EPE 304). In some embodiments, the incoupler 212 and the EPE 304 each include a set of reflective facets. It should be understood that FIG. 3 shows a case in which incoupler 212 directs light straight down (with respect to the presently illustrated view) in a first direction that is perpendicular to the scanning axis 302, and the EPE 304 directs light to the right (with respect to the presently illustrated view) in a second direction that is perpendicular to the first direction. While not shown in the present example, it should be understood that, in some embodiments, the first direction in which the incoupler 212 directs light is slightly or substantially diagonal, rather than exactly perpendicular, with respect to the scanning axis 302.

In some embodiments, each of the incoupler 212, EPE 304, and outcoupler 214 include a corresponding set of reflective facets. For example, each of the plurality of reflective incoupler facets or the plurality of reflective EPE facets is coated with a reflective coating (e.g., dichroic, dielectric, metallic, holographic, or other type of coating) depending on the amount or type of light incident thereon that is to be reflected or transmitted as further discussed in the ensuing figures.

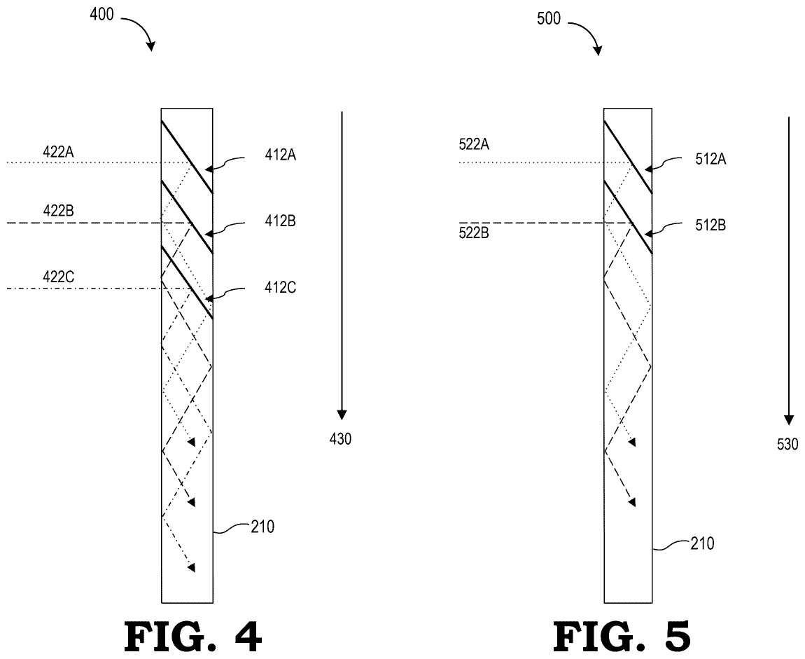

FIG. 4 shows an example diagram 400 of an incoupler with a plurality of reflective incoupler facets 412A, 412B, 412C in a waveguide 210 according to some embodiments. The plurality of reflective incoupler facets 412A, 412B, 412C collectively form an incoupler (not labeled for clarity purposes) such as incoupler 212 illustrated in FIGS. 2 and 3. The direction 430 of light propagation (e.g., toward an EPE) within the waveguide 210 is also illustrated in FIG. 4. While three reflective incoupler facets 412A, 412B, 412C are shown in FIG. 4, this is a matter of design choice and may be scalable to other quantities.

As illustrated, the plurality of reflective incoupler facets 412A, 412B, 412C is positioned such that each reflective incoupler facet of the plurality of reflective incoupler facets after a first reflective incoupler facet of the plurality of reflective incoupler facets is arranged along the direction 430 of light propagation within the waveguide. That is, the first reflective incoupler facet along the path of light propagation is reflective incoupler facet 412A, the second reflective incoupler facet along the path of light propagation is reflective incoupler facet 412B, and the third reflective incoupler facet along the path of light propagation is reflective incoupler facet 412C. Thus, each subsequent reflective incoupler facet is in the path of light propagation of the light incoupled at the previous incoupler. For example, reflective incoupler facet 412B is in the path of light propagation of light incoupled at reflective incoupler facet 412A, and reflective incoupler facet 412C is in the path of light propagation of light incoupled at reflective incoupler facet 412B as well as light incoupled at reflective incoupler facet 412A.

In some embodiments, each reflective incoupler facet 412A, 412B, 412C reflects light having a particular wavelength range or particular color to incouple the light with the particular wavelength range or color into the waveguide. Each particular wavelength range or color is illustrated as a different dashed line in FIG. 4. For example, reflective incoupler facet 412A reflects light 422A having a first wavelength range or color, reflective incoupler facet 412B reflects light 422B having a second wavelength range or color, and reflective incoupler facet 412C reflects light 422C having a third wavelength range or color. In some embodiments, each of light beams 422A, 422B, 422C is received from a different input. For example, each of light beams 422A, 422B, 422C is generated by a different image source, such as image source 202 in FIG. 2, which may be implemented as a microLED display. In some embodiments, light beam 422A is generated by a first microLED display or a first subset of elements of a microLED display, light beam 422B is generated by a second microLED display or a second subset of elements of the microLED display, and light beam 422C is generated by a third microLED display or a third subset of elements of the microLED display.

Furthermore, in some embodiments, each reflective incoupler facet after the first reflective incoupler facet allows light incoupled at the previous reflective incoupler facet to pass through. In this manner, reflective incoupler facet 412B allows light incoupled at reflective incoupler facet 412A to pass through, and reflective incoupler facet 412C allows light incoupled at both of reflective incoupler facets 412B, 412A to pass through. In other words, each reflective incoupler facet 412A, 412B, 412C is to reflect light of the corresponding light beam 422A, 422B, 422C incident thereon and to allow light incoupled at a previous incoupler to pass through (i.e., transmit light incoupled at a previous incoupler).

In a first example implementation, light beam 422A corresponds to red light and reflective incoupler facet 412A reflects red light, light beam 422B corresponds to green light and reflective incoupler facet 412B reflects green light while allowing red light to pass through, and light beam 422C corresponds to blue light and reflective incoupler facet 412C reflects blue light while allowing red and green light to pass through. In a second example implementation, light beam 422A corresponds to blue light and reflective incoupler facet 412A reflects blue light, light beam 422B corresponds to green light and reflective incoupler facet 412B reflects green light while allowing blue light to pass through, and light beam 422C corresponds to red light and reflective incoupler facet 412C reflects red light while allowing blue and green light to pass through. In either implementation, each subsequent reflective incoupler facet along the direction 430 of light propagation in the waveguide 210 reflects and incouples light of a particular wavelength range or color while allowing light incoupled at a previous incoupler (along the direction 430 of light propagation within the waveguide) to pass through. Thus, one or more of the reflective incoupler facets (e.g., reflective incoupler facets 412B and 412C) include a dichroic mirror or dichroic mirror coating with a cut-off wavelength to reflect or transmit light depending on the light's wavelength range. By designing each reflective incoupler facet 412A, 412B, 412C to selectively incouple light of a particular wavelength range from multiple image sources, the light from each image source is combined within the waveguide 210, thereby increasing the amount of light that is incoupled into the waveguide. This increases the amount of light that is eventually outcoupled by the waveguide 210, resulting in a brighter image that is perceived by a user of an eyewear display with the waveguide 210.

FIG. 5 shows an example diagram 500 of an incoupler with a plurality of reflective incoupler facets 512A, 512B in a waveguide 210 according to some embodiments. The plurality of reflective incoupler facets 512A, 512B collectively form an incoupler (not labeled for clarity purposes) such as incoupler 212 illustrated in FIGS. 2 and 3. The direction 530 of light propagation (e.g., toward an EPE) within the waveguide 210 is also illustrated in FIG. 5. While two reflective incoupler facets 512A, 512B are shown in FIG. 5, this is a matter of design choice and may be scalable to other quantities.

As illustrated, example diagram 500 is similar to the example diagram 400 shown in FIG. 4 with the exception that two reflective incoupler facets 512A, 512B are shown instead of three. In addition, in FIG. 5, the reflective incoupler facets 512A, 512B selectively incouple light having different polarization states instead of different wavelength ranges. That is, each reflective incoupler facet 512A, 512B reflects light having a particular polarization state, where light beams with different polarization states are illustrated as different dashed lines in example diagram 500. Furthermore, each subsequent reflective incoupler facet allows light incoupled at a previous incoupler facet to pass through. For example, reflective incoupler facet 512B allows light incoupled at reflective incoupler facet 512A to pass through.

In an example implementation, the first reflective incoupler facet 512A is a mirror. Light beam 522A has a p-polarization state and is emitted from a first image source. The first reflective incoupler facet 512A reflects light beam 522A so that it is incoupled into the waveguide 210. The second reflective incoupler facet 512B is a polarization beam splitter to transmit light having a p-polarization state and reflect light having an s-polarization state. Light beam 522B has an s-polarization state and is emitted from a second image source. In this manner, second reflective incoupler facet 512B reflects light beam 522B such that it is incoupled into the waveguide 210 and allows light incoupled at first reflective incoupler facet 512A to pass through. Thus, reflective incoupler facet 512B includes a polarization beam splitter or polarization beam splitter coating configured to reflect or transmit light depending on the light's polarization state. By designing each reflective incoupler facet 512A, 512B, to selectively incouple light of a particular polarization state from multiple image sources, the light from each image source is combined within the waveguide 210, thereby increasing the amount of light that is incoupled into the waveguide. This increases the amount of light that is eventually outcoupled by the waveguide 210, resulting in a brighter image that is perceived by a user of an eyewear display with the waveguide 210.

In some embodiments, the implementations shown in FIG. 4 (selective incoupling based on wavelength range or color) and in FIG. 5 (selective incoupling based on polarization state) is a matter of design choice. In some embodiments, one implementation may be preferable over the other based on the type of image source in the eyewear display. For example, in some embodiments, the implementation shown in FIG. 4 may be more suitable in cases where the image source includes one or more microLED displays.

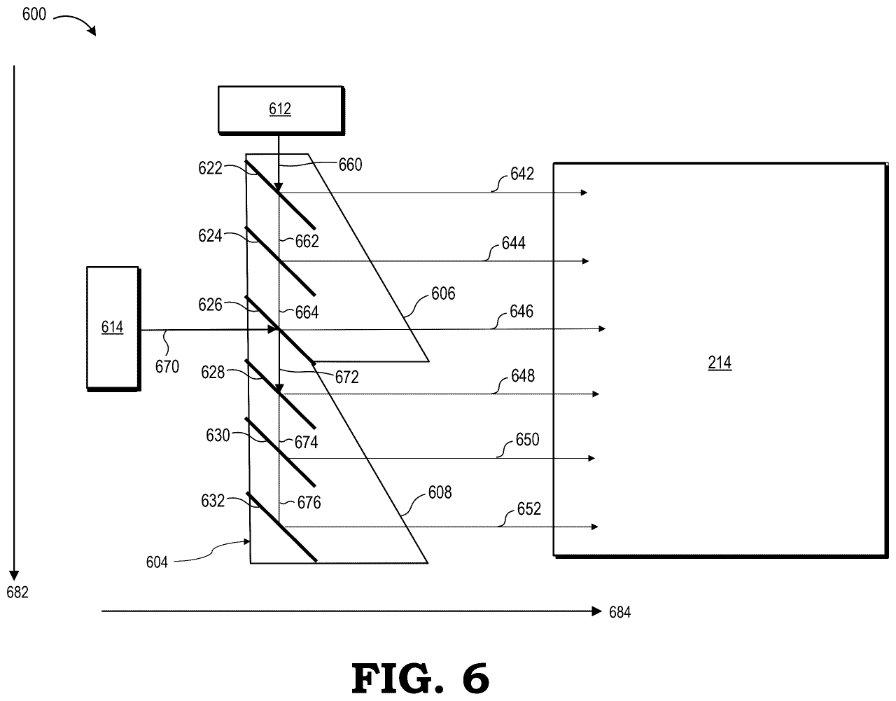

FIG. 6 shows an example diagram 600 of an EPE 604 (such as one corresponding to EPE 304) with a plurality of reflective EPE facets 622-632 according to some embodiments. The number of reflective EPE facets shown in diagram 600 is a matter of design choice and may be scalable to other quantities. As illustrated in diagram 600, the EPE 604 receives light from sources 612, 614 and directs the light toward outcoupler 214. In some embodiments, each of the multiple sources 612, 614 is a different incoupler in the waveguide including EPE 304 and outcoupler 214. For example, source 612 is a first incoupler in a waveguide that receives light from a first image source such as image source 202 and source 614 is a second incoupler in the waveguide that receives light from a second image source such as another image source 202 (the waveguide, first image source, and second image source are not shown in FIG. 6 for clarity purposes).

In some embodiments, the plurality of reflective EPE facets 622-632 is arranged along a direction that is different from a direction toward the outcoupler 214. For example, the plurality of reflective EPE facets 622-632 is arranged along a first direction 682 that is different from the second direction 684 toward the outcoupler 214. In some embodiments, the EPE 604 includes a sawtooth shaped profile with multiple protrusions 606, 608. The number of protrusions shown in diagram 600 is a matter of design choice and may be scalable to other quantities. Each of the multiple protrusions 606, 608 includes a segment of the plurality of reflective EPE facets 622-632. For example, as illustrated in diagram 600, protrusion 606 includes a first segment of reflective EPE facets 622-626 and protrusion 608 includes a second segment of reflective EPE facets 628-632. In some embodiments, the sawtooth shaped profile of the EPE 604 shown in FIG. 6 occupies less space in the waveguide than a conventionally shaped EPE (e.g., with a trapezoidal shaped profile).

As shown in diagram 600, in some embodiments, a first source 612 transmits light 660 in a first direction 682 and a second source 614 transmits light 670 in a second direction 684. In some embodiments, the plurality of reflective EPE facets 622-632 is split into multiple subsets, with each subset being configured to receive light from one of the two sources 612, 614, expand the light along the first direction 682, and transmit the light in a second direction 684 toward the outcoupler 214. For example, referring to FIG. 6, a first subset of reflective EPE facets 622-626 receives light 660 from the first source 612 and directs the light to a top portion of the outcoupler 214 while a second subset of EPE facets 626-632 receives light 670 from the second source 614 and directs the light to a bottom portion of the outcoupler 214. In this scenario, the first set of reflective EPE facets 622-626 and the second subset of reflective EPE facets 626-632 share a reflective EPE facet, e.g., reflective EPE facet 626. However, in other scenarios, each subset of reflective EPE facets is a unique subset, i.e., there are no shared reflective EPE facets between the subsets.

As illustrated in diagram 600, a first subset of reflective EPE facets 622-626 includes an input reflective EPE facet 622 to initially receive light 660 from the first source 612. The input reflective EPE facet 622 of the first subset of reflective EPE facets 622-626 reflects a first portion 642 of the light incident thereon (i.e., corresponding to light 660) in the second direction 684 toward the outcoupler 214 and allows a second portion 662 of the light incident thereon to pass through in the first direction 682. The second reflective EPE facet 624 of the first subset of reflective EPE facets 622-626 receives the light 662 that passes through the input reflective EPE facet 622, reflects a first portion 644 of the light incident thereon (i.e., corresponding to light 662) in the second direction 684 toward the outcoupler 214, and allows a second portion 664 of the light incident thereon to pass through in the first direction 682. The third reflective EPE facet 626 of the first subset of reflective EPE facets 622-626 receives the light 664 that passes through the second reflective EPE facet 624, reflects all of the light incident thereon (i.e., corresponding to light 664) in the second direction 684 toward the outcoupler 214 as reflected light 646.

Similarly, a second subset of reflective EPE facets 626-632 includes an input reflective EPE facet 626 to initially receive light 670 from the second source 614. In some embodiments, the input reflective EPE facet 626 of the second subset of reflective EPE facets 626-632 reflects all of the light incident thereon (i.e., corresponding to light 670) in the first direction 682 as reflected light 672. The second reflective EPE facet 628 of the second subset of reflective EPE facets 626-632 receives the light 672 that reflects off of the input reflective EPE facet 626, reflects a first portion 648 of the light incident thereon (i.e., corresponding to light 662) in the second direction 684 toward the outcoupler 214, and allows a second portion 674 of the light incident thereon to pass through in the first direction 682. The third reflective EPE facet 630 of the second subset of reflective EPE facets 626-632 receives the light 674 that passes through the second reflective EPE facet 628 of the second subset of reflective EPE facets 626-632, reflects a first portion 650 of the light incident thereon (i.e., corresponding to light 674) in the second direction 684 toward the outcoupler 214, and allows a second portion 676 of the light incident thereon to pass through in the first direction 682. The fourth reflective EPE facet 632 of the second subset of reflective EPE facets 626-632 receives the light 676 that passes through the third reflective EPE facet 630 in the second subset of reflective EPE facets 626-632, reflects all of the light incident thereon (i.e., corresponding to light 676) in the second direction 684 toward the outcoupler 214 as light 652. By designing each of the reflective EPE facets 622-632 to have a particular transmission to reflection ratio for light incident thereon, the light 642-652 transmitted to the outcoupler 214 is uniform (i.e., equal in power or substantially equal in power to one another), thereby improving the uniformity of light eventually outcoupled by outcoupler 214. This improves the quality of the image delivered to the user.

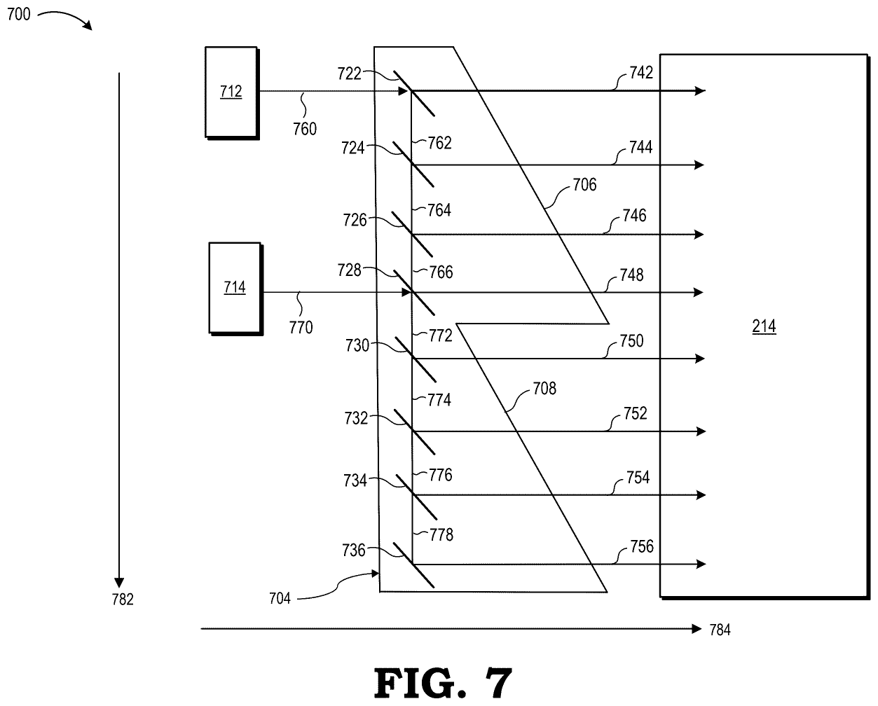

FIG. 7 shows another example diagram 700 of an EPE 704 (such as one corresponding to EPE 304) with a plurality of reflective EPE facets 722-736. The number of reflective EPE facets shown in diagram 700 is a matter of design choice and may be scalable to other quantities. As illustrated in diagram 700, the EPE 704 receives light from sources 712, 714 and directs the light toward outcoupler 214. In some embodiments, each of the multiple sources 712, 714 is a different incoupler in the waveguide including EPE 704 and outcoupler 214. For example, source 712 is a first incoupler in a waveguide that receives light from a first image source and source 714 is a second incoupler in the waveguide that receives light from a second image source (the waveguide, first image source, and second image source are not shown in FIG. 7 for clarity purposes).

In some embodiments, the plurality of reflective EPE facets 722-736 is arranged along a direction that is different from a direction toward the outcoupler 214. For example, the plurality of reflective EPE facets 722-736 is arranged along a first direction 782 that is different from the second direction 784 toward the outcoupler 214. In some embodiments, the EPE 704 includes a sawtooth shaped profile with multiple protrusions 706, 708. The number of protrusions shown in diagram 700 is a matter of design choice and may be scalable to other quantities. Each of the multiple protrusions 706, 708 includes a portion of the plurality of reflective EPE facets 722-736. For example, as illustrated in diagram 700, protrusion 706 includes a first segment of reflective EPE facets 722-728 and protrusion 708 includes a second segment of reflective EPE facets 730-736. In some embodiments, the sawtooth shaped profile of the EPE 704 shown in FIG. 7 occupies less space in the waveguide than a conventionally shaped EPE (e.g., with a trapezoidal shaped profile).

As shown in diagram 700, in some embodiments, the first source 712 and the second source 714 transmit light in the same direction. For example, as shown in diagram 700, the first source 712 transmits light 760 in the second direction 784 and the second source 714 also transmits light 770 in the second direction 784. In some embodiments, the plurality of reflective EPE facets 722-736 is split into multiple subsets, with each subset being configured to receive light from one of the two sources 712, 714, expand the light along the first direction 782, and transmit the light in a second direction 784 toward the outcoupler 214. For example, referring to FIG. 7, a first subset of reflective EPE facets 722-728 receives light from the first source 712 and directs the light to a top portion of the outcoupler 214 while a second subset of EPE facets 728-736 receives light from the second source 714 and directs the light to a bottom portion of the outcoupler 214. As described in this scenario, in some embodiments, a first subset of reflective EPE facets 722-728 and a second subset of reflective EPE facets 728-736 share a reflective EPE facet, e.g., reflective EPE facet 728. However, in other scenarios, each subset of reflective EPE facets is a unique subset, i.e., there are no shared reflective EPE facets between the subsets.

In some embodiments, the intensity of light from each image source 712, 714 is equal. Referring to the eight reflective EPE facet configuration shown in FIG. 7, an example of the reflection to transmission properties of each of the reflective EPE facets 722-736 is summarized in Table I below. In some embodiments, each of the reflective EPE facets may be designed with other reflective and transmission properties depending on design considerations.

TABLE I

| Reflective | % | % | |
|---|---|---|---|
| EPE Facet | Reflection | Transmission | Power to OC 214 |
| 722 | 75% | 25% | 25% P (from 712) |
| 724 | 33% | 67% | 25% P (from 712) |
| 726 | 50% | 50% | 25% P (from 712) |
| 728 | 100% | 0% | 25% P (from 712) |
| 730 | 25% | 75% | 25% P (from 714) |
| 732 | 33% | 67% | 25% P (from 714) |
| 734 | 50% | 50% | 25% P (from 714) |
| 736 | 100% | 0% | 25% P (from 714) |

The first subset of reflective EPE facets 722-728 direct light from source 712 toward the outcoupler 214 as follows. Referring to reflective EPE facet 722 (also referred to as the input reflective EPE facet for the first subset of reflective EPE facets), 75% of the light incident thereon (i.e., light 760) is reflected as light 762 and 25% of the light incident thereon is transmitted as light 742 toward the outcoupler 214. Referring to reflective EPE facet 724, 33% of the light incident thereon (i.e., light 762) is reflected as light 744 toward the outcoupler 214 and 67% of the light incident thereon is transmitted as light 764. Referring to reflective EPE facet 726, 50% of the light incident thereon (i.e., referring to light 764) is reflected as light 746 and 50% of the light incident thereon is transmitted as light 766. Referring to reflective EPE facet 728, 100% of the light incident thereon (i.e., referring to light 766) is reflected as light 748. In this manner, each of the reflective EPE facets in the first subset of reflective EPE facets 722-728 direct 25% of the total power (P) of light 760 received from the first source 712 toward the outcoupler 214.

The second subset of reflective EPE facets 728-736 direct light from source 714 toward the outcoupler 214 as follows. Referring to reflective EPE facet 728 (also referred to as the input reflective EPE facet for the second subset of reflective EPE facets), 100% of the light incident thereon (i.e., light 770) is reflected as light 772. Referring to reflective EPE facet 730, 25% of the light incident thereon (i.e., light 772) is reflected as light 750 and 75% of the light incident thereon is transmitted as light 772. Referring to reflective EPE facet 732, 33% of the light incident thereon (i.e., light 774) is reflected as light 752 and 67% of the light incident thereon is transmitted as light 776. Referring to reflective EPE facet 734, 50% of the light incident thereon (i.e., light 776) is reflected as light 754 and 50% of the light incident thereon is transmitted as light 778. Referring to reflective EPE facet 736, 100% of the light incident thereon (i.e., light 778) is reflected as light 756. By designing each of the reflective EPE facets 722-736 to have a particular transmission to reflection ratio for light incident thereon, the light 742-756 transmitted to the outcoupler 214 is uniform (i.e., equal in power or substantially equal in power to one another), thereby improving the uniformity of light eventually outcoupled by outcoupler 214. This improves the quality of the image delivered to the user.

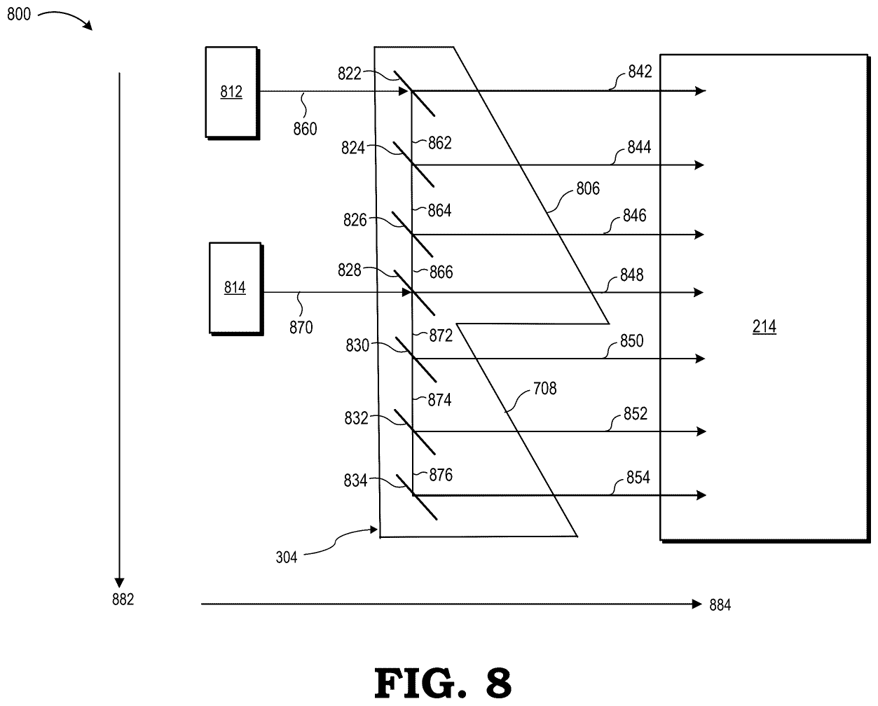

FIG. 8 shows another example diagram 800 of an EPE 804 (such as one corresponding to EPE 304) with a plurality of reflective facets 822-834. The number of reflective EPE facets shown in diagram 800 is a matter of design choice and may be scalable to other quantities. As illustrated in diagram 800, the EPE 804 receives light from sources 812, 814 and directs the light toward outcoupler 214. In some embodiments, each of the sources 812, 814 is a different incoupler in the waveguide including EPE 804 and outcoupler 214. For example, source 812 is a first incoupler in a waveguide that receives light from a first image source and source 814 is a second incoupler in the waveguide that receives light from a second image source (the waveguide, first image source, and second image source are not shown in FIG. 8 for clarity purposes).

In some embodiments, the plurality of reflective EPE facets 822-834 is arranged along a direction that is different from a direction toward the outcoupler 214. For example, the plurality of reflective EPE facets 822-834 is arranged along a first direction 882 that is different from the second direction 884 toward the outcoupler 214. In some embodiments, the EPE 804 includes a sawtooth shaped profile with multiple protrusions 806, 808. The number of protrusions shown in diagram 800 is a matter of design choice and may be scalable to other quantities. Each of the multiple protrusions 806, 808 includes a segment of the plurality of reflective EPE facets 822-834. For example, as illustrated in diagram 800, protrusion 806 includes a first segment of reflective EPE facets 822-828 and protrusion 808 includes a second segment of reflective EPE facets 830-834. In some embodiments, the sawtooth shaped profile of the EPE 804 shown in FIG. 8 occupies less space in the waveguide than a conventionally shaped EPE (e.g., with a trapezoidal shaped profile).

As shown in diagram 800, in some embodiments, the first source 812 and the second source 814 transmit light in the same direction. For example, as shown in diagram 800, the first source 812 transmits light 860 in the second direction 884 and the second source 814 also transmits light 870 in the second direction 874. In some embodiments, the plurality of reflective EPE facets 822-834 is split into multiple subsets, with each subset being configured to receive light from one of the two sources 812, 814, expand the light along the first direction 882, and transmit the light in a second direction 884 toward the outcoupler 214. For example, a first subset of reflective EPE facets 822-828 receives light from the first source 812 and directs the light to a top portion of the outcoupler 214 while a second subset of EPE facets 828-836 receives light from the second source 814 and directs the light to a bottom portion of the outcoupler 214. As described in this scenario, in some embodiments, a first subset of reflective EPE facets 822-828 and a second subset of reflective EPE facets 828-834 share a reflective EPE facet, e.g., reflective EPE facet 828. However, in other scenarios, each subset of reflective EPE facets is a unique subset, i.e., there are no shared reflective EPE facets between the subsets.

In some embodiments, the intensity of light from each image source 812, 814 is equal. Referring to the seven reflective EPE facet configuration shown in FIG. 8, an example of the reflection to transmission properties of each of the reflective EPE facets 822-834 is summarized in Table II below. In some embodiments, each of the reflective EPE facets may be designed with other reflective and transmission properties depending on design considerations.

TABLE II

| Reflective | % | % | Power to |
|---|---|---|---|
| EPE Facet | Reflection | Transmission | OC 214 |
| 822 | 70% | 35% | 30% |
| 824 | 43% | 57% | 30% |
| 826 | 75% | 25% | 30% |
| 828 | 78% | 22% | 30% |
| 830 | 38% | 62% | 30% |
| 832 | 50% | 50% | 25% |
| 834 | 100% | 0% | 25% |

Thus, as shown by Table II, the amount of light power from the sources 812 and 814 that is delivered to the outcoupler may be tuned based on the reflective and transmissive qualities of the reflective EPE facets.

Additional or alternative embodiments to those shown in FIGS. 6 to 8 include situations where the power of light emitted by each of the sources is different (e.g., referring to FIG. 7, the power of the light 760 transmitted from source 712 is different than the power of light 770 transmitted from source 714); balancing the uniformity by varying the sources; or performing more mixing between the two sources (e.g., such as that shown in FIG. 8). In some embodiments, the reflective EPE facets described in FIGS. 6 to 8 include dichroic layers, dielectric layers, metallic layers, holographic layers, or any combination thereof.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A waveguide comprising:
an incoupler comprising a plurality of reflective facets, each reflective facet of the plurality of reflective facets to selectively reflect light having a first optical characteristic of a plurality of optical characteristics, wherein light having each one of the plurality of optical characteristics is received from a different input,
wherein the plurality of reflective facets is positioned such that one or more reflective facets of the plurality of reflective facets is in a path of light propagation of light incoupled at another one of the plurality of reflective facets.

2. The waveguide of claim 1, wherein one or more reflective facets of the plurality of reflective facets allows light incoupled at other ones of the plurality of reflective facets to pass through.

3. The waveguide of claim 2, wherein the plurality of optical characteristics are different wavelength ranges, and wherein the one or more reflective facets of the plurality of reflective facets comprises a dichroic mirror coating.

4. The waveguide of claim 3, wherein a first facet of the plurality of reflective facets is configured to reflect light having a first wavelength range to propagate light having the first wavelength range within the waveguide.

5. The waveguide of claim 4, wherein a second facet of the plurality of reflective facets is configured to allow light having the first wavelength range to pass through and reflect light having a second wavelength range different from the first wavelength range to propagate light having the second wavelength range within the waveguide.

6. The waveguide of claim 5, wherein a third facet of the plurality of reflective facets is configured to allow light having the first wavelength range and the second wavelength range to pass through and reflect light having a third wavelength range different from the first wavelength range and the second wavelength range to propagate light having the third wavelength range within the waveguide.

7. The waveguide of claim 3, wherein a first facet of the plurality of reflective facets is configured to reflect light of a first wavelength range corresponding to blue light, a second facet of the plurality of reflective facets is configured to reflect light of a second wavelength range corresponding to green light, and a third facet of the plurality of reflective facets is configured to reflect light of a third wavelength range corresponding to red light.

8. The waveguide of claim 7, wherein the second facet is configured to allow light having the first wavelength range to pass through, and the third facet is configured to allow light having the first wavelength range and the second wavelength range to pass through.

9. The waveguide of claim 3, wherein a first facet of the plurality of reflective facets is configured to reflect light of a first wavelength range corresponding to red light, a second facet of the plurality of reflective facets is configured to reflect light of a second wavelength range corresponding to green light, and a third facet of the plurality of reflective facets is configured to reflect light of a third wavelength range corresponding to blue light.

10. The waveguide of claim 9, wherein the second facet is configured to allow light having the first wavelength range to pass through, and the third facet is configured to allow light having the first wavelength range and the second wavelength range to pass through.

11. The waveguide of claim 2, wherein the plurality of optical characteristics are different polarization states.

12. The waveguide of claim 11, wherein a first facet of the plurality of reflective facets comprises a mirror to reflect light having a first polarization state and wherein a second facet of the plurality of reflective facets comprises a polarization beam splitter.

13. The waveguide of claim 12, wherein the polarization beam splitter allows light having the first polarization state incoupled at the first facet to pass through and reflects light having a second polarization state.

14. The waveguide of claim 1, wherein light having each of the plurality of optical characteristics is emitted from a different light emitting source.

15. A waveguide, comprising:
an outcoupler; and
an exit pupil expander (EPE) comprising a plurality of reflective facets to receive light from multiple sources, the plurality of reflective facets arranged along a first direction and direct light in a second direction toward the outcoupler, wherein the first direction is different from the second direction.

16. The waveguide of claim 15, wherein a first source of the multiple sources transmits light toward the first direction and a second source of the multiple sources transmits light toward the second direction.

17. The waveguide of claim 16, wherein a first subset of reflective facets of the plurality of reflective facets comprises an input reflective facet to receive light from the first source, reflect a first portion of the received light in the second direction, and allow a second portion of the received light to pass through to other reflective facets in the first subset, wherein each of the other reflective facets in the first subset reflects a corresponding first portion of light incident thereon in the second direction and allows a corresponding second portion of light incident thereon to pass through in the first direction.

18. The waveguide of claim 17, wherein a second subset of reflective facets of the plurality of reflective facets comprises a second input reflective facet to receive light from the second source and reflect the received light to other reflective facets in the second subset, wherein the second input reflective facet corresponds to a final reflective facet in the first subset and comprises a surface with total reflectivity or substantially total reflectivity of light from the first source and the second source.

19. The waveguide of claim 18, wherein each of the other reflective facets in the second subset reflects a corresponding first portion of light incident thereon in the second direction and allows a corresponding second portion of light incident thereon to pass through in the first direction.

20. The waveguide of claim 15, wherein a first source and a second source transmit light toward the second direction.

21. The waveguide of claim 20, wherein a first subset of reflective facets of the plurality of reflective facets comprises an input reflective facet to receive light from the first source, allow a first portion of the received light to pass through in the second direction, and reflect a second portion of the received light in the first direction toward other reflective facets in the first subset.

22. The waveguide of claim 21, wherein the other reflective facets in the first subset reflect a corresponding portion of light incident thereon in the second direction and allow a remaining corresponding portion of light incident thereon to pass through in the first direction.

23. The waveguide of claim 22, wherein a second subset of reflective facets of the plurality of reflective facets receives light from the second source, wherein the second subset of facets comprises an input facet configured to initially receive light from the second source, transmit a first portion of the received light in the second direction, and reflect a second portion of the received light toward other facets in the second subset.

24. The waveguide of claim 23, wherein the other facets in the second subset reflect a portion of light incident thereon in the second direction.

25. An eyewear display, comprising:
a waveguide according to claim 1.

26. A method comprising:
at each one of a plurality of reflective facets in an incoupler of a waveguide, selectively reflecting light having a first optical characteristic of a plurality of optical characteristics, wherein light having each one of the plurality of optical characteristics is received from a different input; and
at one or more of the plurality of reflective facets, allowing light incoupled at another one or more of the plurality of reflective facets to pass through.

27. (canceled)
